(19) United States
(12) Patent Application Publication
(10) Pub. No.: US 2018/0025822 A1
(43) Pub. Date: Jan. 25, 2018

(54) SOFT MAGNETIC METAL DUST CORE AND REACTOR HAVING THEREOF

(71) Applicant: TDK CORPORATION, Tokyo (JP)

(72) Inventors: Yu YONEZAWA, Tokyo (JP); Tomofumi KURODA, Tokyo (JP); Yusuke TANIGUCHI, Tokyo (JP)

(73) Assignee: TDK CORPORATION, Tokyo (JP)

(21) Appl. No.: 15/656,242

(22) Filed: Jul. 21, 2017

(30) Foreign Application Priority Data
Jul. 25, 2016 (JP) 2016-145313

(51) Int. Cl. H01F 1/20; B22F 1/00; B22F 1/02

(52) U.S. Cl. CPC H01F 1/20; B22F 1/02; B22F 1/0014

(57) ABSTRACT

A soft magnetic metal dust core including a soft magnetic metal powder and a nonmagnetic material, in which when observing a field of view including “n”, a natural number of 50 or more, particles of the soft magnetic metal powder on a grinded smooth cross section of the dust core, the soft magnetic metal powder is coated by the nonmagnetic material, and a number of an opposing part P is n/2 or more, in which the opposing part P is a part where a length L is 10 μm or more, and the length L is a continuous length where a distance between particles of the soft magnetic metal powder is 400 nm or less, is provided. The soft magnetic metal dust core is superior in DC superimposing characteristic.

### BACKGROUND OF THE INVENTION

### 1. Field of the Invention

The present invention relates to a soft magnetic metal dust core having a soft magnetic metal powder and a reactor having the soft magnetic metal dust core.

### 2. Description of the Related Art

Miniaturization of electric and electronic devices is processing, and a miniaturized soft magnetic metal dust core with high efficiency is demanded. A ferrite core, a laminated electromagnetic steel plate, a soft magnetic metal dust core, the core manufactured by a metal mold molding, an injection molding, a sheet molding, etc., using the soft magnetic metal powder, are used as a core material of a reactor and an inductor used to apply a large current. The laminated electromagnetic steel plate attains a large saturated magnetic flux density, however, provides a high iron loss at high frequencies, in which a driving frequency of a power circuit is over several tens kHz. This lead to a problem of reduction in efficiency. While the ferrite core is a core material which attains a low loss at high frequencies, however, provides a small saturated magnetic flux density. This lead to a problem of enlarging the core shape.

The iron loss at high frequencies of the soft magnetic metal dust core is smaller than the same of the laminated electromagnetic steel plate, and the saturated magnetic flux density of the soft magnetic metal dust core is larger than the same of the ferrite core. Thus, the soft magnetic metal dust core is widely used as the core material for the reactor and the inductor. To miniaturize the core, it is required to show a superior relative permeability particularly at a high magnetic field where direct currents are superimposed, namely, the core is required to show a superior DC superimposing characteristic. To show the superior DC superimposing characteristic, a high relative permeability μ is required in a DC superimposed magnetic field of 0 to 8 kA/m. Specially, relative permeability μ (8 kA/m) in a DC superimposed magnetic field of 8 kA/m is required to be high. Generally, μ (8 kA/m) tends to decrease as the relative permeability μ0 in a magnetic field where DC is not superimposed becomes higher. Thus, a characteristic showing both a high μ (8 kA/m) and a high μ0 defines the superior DC superimposing characteristic. To attain the superior DC superimposing characteristic, it is practical to use the soft magnetic metal dust core having a high saturated magnetic flux density and to make a highly-dense soft magnetic metal dust core. In addition, it is also known that enhancing the uniformity of the soft magnetic metal dust core inner structure and preventing mutual contacts of the soft magnetic metal powder particles included in the soft magnetic metal dust core are effective for an improvement of the DC superimposing characteristic.

Thus, patent article 1 mentions the DC superimposing characteristic can be improved by using the reactor including the soft magnetic metal powder having an average particle diameter of 1 μm or more and 70 μm or less, a variation coefficient Cv, a ratio of a standard deviation of the particle diameter and the average particle diameter, of 0.40 or less, and the circularity of 0.8 or more and 1.0 or less, and thus, enhancing the uniformity of inside a molded body.

Patent article 2 mentions magnetic characteristic can be improved by coating boron nitride on the surface of the soft magnetic metal powder making a coat superior in deformation and achieving a higher density.

Patent article 3 mentions the DC superimposing characteristic can be improved by using a spacing material and securing a distance between particles of the soft magnetic metal powder during compression molding.

Patent Document 1: JP 2009-70885A

Patent Document 2: JP 2010-236021A

Patent Document 3: JP H11-238613A

### DISCLOSURE OF THE INVENTION

### Means for Solving the Problems

The technique described in Patent Document 1 mentions DC superimposing characteristic can be improved by making the average particle diameter of the soft magnetic metal powder to 1 μm or more and 70 μm or less, the circularity to 0.8 or more and 1.0 or less, and the variation coefficient Cv, the ratio of a standard deviation of the particle diameter and the average particle diameter, to 0.40 or less. However, the particle diameter distribution of the soft magnetic metal powder is required to have an extremely sharp peak when said variation coefficient is within the above range. Thus, there is a problem that the filling density inevitably lowers when molding the soft magnetic metal dust core. As a result, there is a problem that density of the obtained soft magnetic metal dust core lowers, leading to a deterioration of the DC superimposing characteristic.

The technique described in Patent Document 2 mentions that the use of the soft magnetic material, in which a boron nitride included insulation layer is coated on the soft magnetic metal powder, enables the high-dense without corrupting the insulation layer during the compression molding. This is because the coat including boron nitride follows the deformation of the soft magnetic metal powder when molded, and the boron nitride coat exists on the surface of the soft magnetic metal powder even deformed for the high-dense which contributes to the insulation. The high-dense makes the saturated magnetic flux density high and an improvement of the DC superimposing characteristic is expected, however, in practical, the boron nitride coat exists between particles of the soft magnetic metal powder which widen the distance between the particles, and lowers the relative permeability, and there is a problem that a good DC superimposing characteristic is unable to be obtained.

The technique described in Patent Document 3 mentions that the use of the soft magnetic metal powder and the spacing material secures the minimum required space between particles of the soft magnetic metal powder, and reduces the distance between the particles, and thus enables an improvement of the DC superimposing characteristic. The distance between particles of the soft magnetic metal powder can be secured by the spacing material, however, magnetizations of the soft magnetic metal powder are distributed due to the distributed distances between the particles. As a result, the uniformity of inside the soft magnetic metal dust core lowers, and there is a problem that the DC superimposing characteristic is not capable to be sufficiently improved.

Thus, with the conventional techniques, there is a problem that a good DC superimposing characteristic cannot be obtained. Therefore, the soft magnetic metal dust core superior in DC superimposing characteristic is demanded.

The present invention was devised to solve the above problems, and to provide a soft magnetic metal dust core superior in DC superimposing characteristic.

In order to solve the above problems, the soft magnetic metal dust core of the invention includes a soft magnetic metal powder and a nonmagnetic material, in which when observing a field of view including “n”, a natural number of 50 or more, particles of the soft magnetic metal powder on a grinded smooth cross section of the dust core, the soft magnetic metal powder is coated by the nonmagnetic material, and a number of opposing part P is n/2 or more. The opposing part P is a part where a length L is 10 μm or more. The length L is a continuous length where a distance between particles of the soft magnetic metal powder is 400 nm or less. Considering above, soft magnetic metal dust core of the invention can be superior in DC superimposing characteristic. When observing the field of view on the smooth cross section, a circularity of a cross section of 80% or more particles of the soft magnetic metal powder is preferably 0.75 or more and 1.00 or less. Further, when observing the field of view on the smooth cross section, 68% or more of the opposing part P show that a closest distance X is 50 nm or more, in which the closest distance X is the shortest distance among the distances between particles at the opposing part P.

When observing the field of view on the smooth cross section, an occupancy area ratio of the soft magnetic metal powder to the field of view is 90% or more and 95% or less. Thus, soft magnetic metal dust core can be further superior in DC superimposing characteristic.

The nonmagnetic material includes Silicon (Si) and Oxygen (O). Thus, the soft magnetic metal dust core can be further superior in DC superimposing characteristic.

It is preferable that the nonmagnetic material includes boron nitride, and includes 0.80 mass % or less of Boron (B) and 1.00 mass % or less of Nitrogen (N), with respect to the soft magnetic metal dust core. Thus, the soft magnetic metal dust core can be further superior in DC superimposing characteristic.

According to a particle size distribution of the soft magnetic metal powder, it is preferable that d50% is 20 μm or more and 70 μm or less, when d50% is a particle diameter of a 50% particle, obtained by accumulating particle numbers from smaller size. Thus, the soft magnetic metal dust core can be further superior in DC superimposing characteristic.

A reactor having the soft magnetic metal dust core of the invention can improve DC superimposing characteristic.

The present invention provides the soft magnetic metal dust core superior in DC superimposing characteristic.

### BRIEF DESCRIPTION OF THE DRAWINGS

FIG. 1 is a schematic cross section showing a soft magnetic metal dust core structure of an embodiment of the present invention.

FIG. 2 is a schematic cross section showing a soft magnetic metal dust core structure of an embodiment according to the present invention, in which measurement methods of the distance between particles of the soft magnetic metal powder, a length L where the distance between particles is continuously 400 nm or less, and an opposing part P where the length L is continuous for 10 μm or more.

FIG. 3 is the cross section of the soft magnetic metal dust core of Ex. 1-1 observed by SEM.

FIG. 4A, FIG. 4B and FIG. 4C are in-plane density distributions of silicon (Si), oxygen (O), carbon (C), respectively, which are the cross section of the soft magnetic metal dust core of Ex. 1-1 observed by EDS.

FIG. 5 is a schematic view of the reactor manufactured by using the soft magnetic metal dust core of the invention.

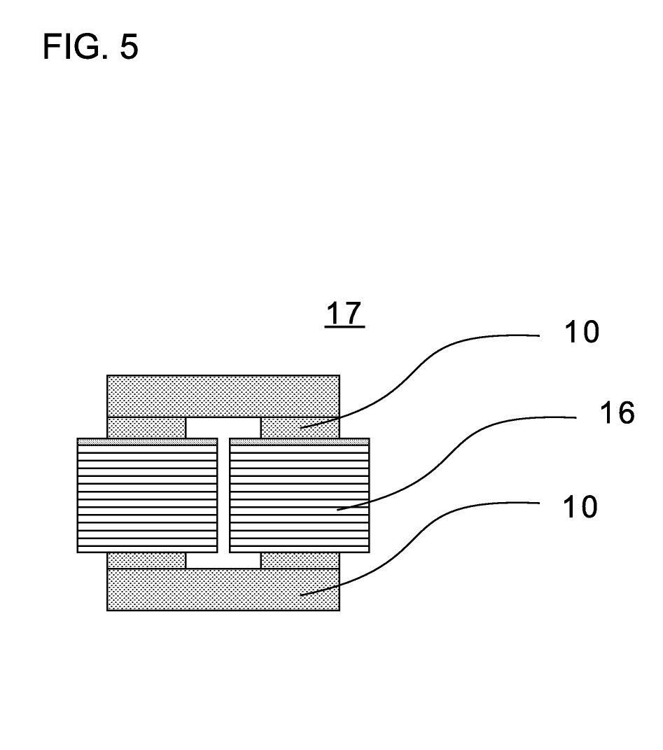

### DESCRIPTION OF THE PREFERRED EMBODIMENTS

The soft magnetic metal dust core of the invention includes the soft magnetic metal powder and the nonmagnetic material, in which when observing a field of view including “n”, a natural number of 50 or more, particles of the soft magnetic metal powder on a grinded smooth cross section of the dust core, the soft magnetic metal powder is coated by the nonmagnetic material, and a number of an opposing part P is n/2 or more, wherein the opposing part P is a part where a length L is 10 μm or more, and the length L is a continuous length where a distance between particles of the soft magnetic metal powder is 400 nm or less.

Hereinafter, an embodiment of the present invention will be described referring to the figures.

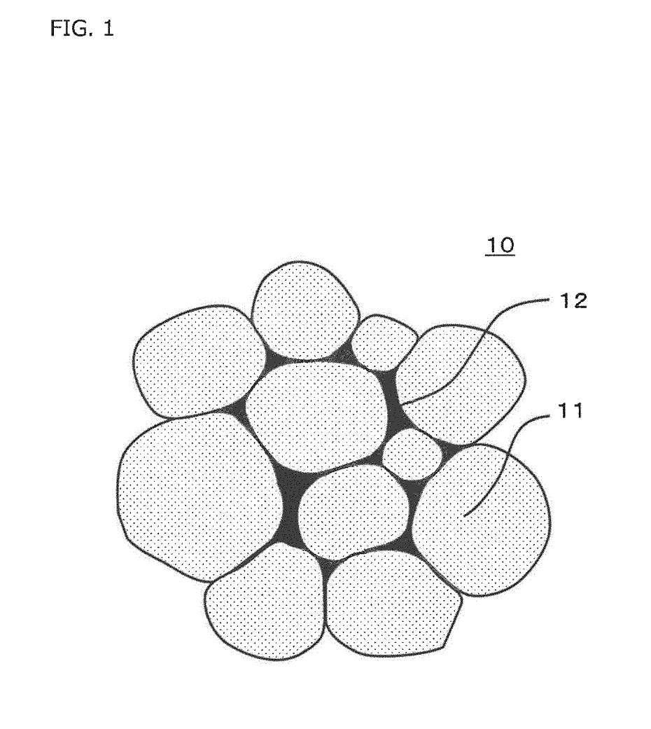

FIG. 1 is a schematic view showing a cross section structure of soft magnetic metal dust core 10. Soft magnetic metal dust core 10 is composed of soft magnetic metal powder 11 and nonmagnetic material 12, coating most of the particle surfaces constituting the soft magnetic metal powder 11. Soft magnetic metal powder 11 is the soft magnetic metal mainly composed of iron, and pure irons, Fe—Si alloys, Fe—Si—Cr alloys, Fe—Al alloys, Fe—Si—Al alloys, Fe—Ni alloys, etc. may be used. To obtain a good DC superimposing characteristic, the soft magnetic metal powder with high saturation of the magnetization is preferably used. Thus, pure irons, Fe—Si alloys and Fe—Ni alloys are preferably used. Nonmagnetic material 12 coats most surface of soft magnetic metal powder 11, and shows a high electrical resistance for inhibiting a loss by eddy current flowing between particles of the soft magnetic metal powder 11. For instance, materials mainly including Si, O and C, such as an epoxy resin, which include nanosilica that is fine particles of silicone dioxide having an average particle diameter of several tens to several hundreds nm, a silicone resin, etc. can be used.

For an observation of the soft magnetic metal dust core cross section, a plane, cut at the plane passing through the points existing 1 mm or more inside the soft magnetic metal dust core surface, and grinded by a grinder to be the smooth cross section, was used. Scanning electronic microscope (SEM) was used for the cross section observation. For the soft magnetic metal dust core, the soft magnetic metal powder having a particle diameter of several tens μm was used for suppressing the eddy current and obtaining a desired μ0. By cutting the plane passing through the points existing 1 mm or more inside the soft magnetic metal dust core surface, a required particle numbers of the soft magnetic metal powder for an evaluation can be secured at a microstructure of the soft magnetic metal dust core on the smooth cross section.

For the cross section observation, the particle number of the soft magnetic metal powder included in the field of view is set to be 50 or more. In case when the particle numbers of the soft magnetic metal powder included in the field of view is less than 50, it is concerned that particular points having a low existence ratio may be overvalued, when evaluating the below described distance between particles and opposing part P of the soft magnetic metal powder. Thus, to suppress overvalue of the particular points, the particle number is required to be 50 or more. In case when particle numbers of the soft magnetic metal powder included in the field of view is less than 50, the particle number is changed to be 50 or more by changing such as the magnification of the microscope.

When the smooth cross section of the soft magnetic metal dust core is observed and the circularity of the soft magnetic metal powder is measured, the circularity of 80% or more particles constituting the soft magnetic metal powder is preferably 0.75 to 1.00. Wadell's circularity can be used as an example of the circularity evaluation. Wadell's circularity is determined by a ratio of a diameter of a circle equal to a projection area of a particle cross section to a diameter of a circle circumscribed on the particle cross section. In case of a perfect circle, Wadell's circularity is 1, and the circularity is high as it gets close to 1. The circularity can be calculated by image analyzing the cross section obtained from the observation.

The curvature of the particle surface is not fixed according to the particles having a low circularity. Thus, distribution of the nonmagnetic material thickness is often generated and a stress applied when molding becomes uneven. Therefore, when molding, the thickness of the nonmagnetic material coating the soft magnetic metal powder becomes uneven. Thus, in case when the particles having the low circularity are high in content, the distances between particles are distributed and saturation of the magnetization becomes uneven during magnetization process. As a result, DC superimposing characteristic is deteriorated. Considering above, a good DC superimposing characteristic can be obtained by making 80% or more of the particle circularities 0.75 to 1.00. More preferably, a superior DC superimposing characteristic can be obtained by making the circularities of 85% or more particles to 0.75 to 1.00.

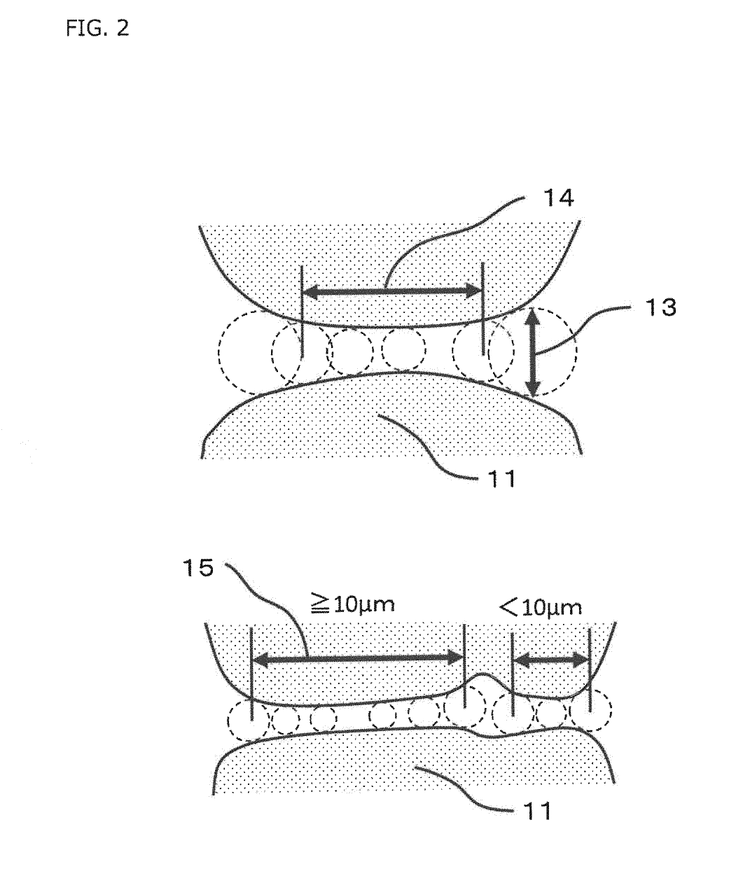

FIG. 2 is a schematic view showing measuring methods of distance:13 between particles of soft magnetic metal powder 11 existing on the cross section of the soft magnetic metal dust core, length L:14 where the distances between particles is continuously 400 nm or less, and opposing part P:15 where length L:14 is 10 μm or more. The distance between particles 13 of soft magnetic metal powder 11 is a diameter of a circle disposed between particles which touch the surfaces of two adjacent particles of the soft magnetic metal powder. Note that the diameter of the circle is determined as zero when the two adjacent particles contact each other. Here, when a plural number of circles are disposed between two particles, a distance between centers of the circles exiting on both sides of a part, where circles having diameters of 400 nm or less are continuously existed, is determined as length L:14. In case when length L:14 is 10 μm or more, a part, where circles having diameters of 400 nm or less are continuously existed, is determined as opposing part P:15. In case when the distance between particles is 400 nm or more, particles are mutually separated making it difficult for a magnetic flux to pass. This lowers μ0, and a superior DC superimposing characteristic cannot be obtained. In case when length L:14 is less than 10 μm, an area where the particles of the soft magnetic metal powder mutually being close is small and a progress of the magnetization is distributed. Thus, a superior DC superimposing characteristic cannot be obtained. While when length L, where the distance between particles is continuously 400 nm or less, is 10 μm or more, a magnetic flux of particles between the soft magnetic metal easily and uniformly flow, and a local saturation of the magnetization can be suppressed. Thus, when length L, where the distance between particles is continuously 400 nm or less, is 10 μm or more, a good DC superimposing characteristic can be obtained.

From the observation of the cross section of the soft magnetic metal dust core, a number of opposing part P is n/2 or more relative to an arbitrary particle number “n” of the soft magnetic metal powder in the field of view. The present inventors found that, when the number of opposing part P is n/2 or more relative to the particle number “n” of the soft magnetic metal powder included in the field of view, the DC superimposing characteristic of the soft magnetic metal dust core is good. In such cases, in the soft magnetic metal dust core, most of the particles of the soft magnetic metal powder are considered to show opposing part P with adjacent particles. Namely, many particles of the soft magnetic metal powder mutually contact, a magnetic flux concentration is suppressed and a uniform magnetization is promoted. While when the number of opposing part P is less than n/2, in the soft magnetic metal dust core, there are less places where the distance between particles of the soft magnetic metal powder is as close as 400 nm or less. In case when there are few places where particles of the soft magnetic metal powder are proximate, a progress of the particle magnetization is distributed and an improvement of the DC superimposing characteristic cannot be expected. Thus, when the number of opposing part P is n/2 or more with respect to an arbitrary particle number “n” of the soft magnetic metal powder in the field of view, a good DC superimposing characteristic can be obtained.

In each opposing part P, a diameter of a circle having the smallest diameter is determined as a closest distance X. The present inventors found that, when 68% or more of opposing part P show that closest distance X is 50 nm or more relative to opposing part P, a good DC superimposing characteristic can be obtained. Since 68% or more of opposing part P show that the closest distance X is 50 nm or more relative to opposing part P, many particles of the soft magnetic metal powder do not contact, and are proximate via nonmagnetic materials having a predetermined thickness. Thus, it is considered that the magnetic flux uniformly flows and the magnetization progresses when there are many areas where the distance between particles of the soft magnetic metal powder show a predetermined distance or more, leading to a good DC superimposing characteristic. More preferably, 72% or more of opposing part P show that the closest distance X is 50 nm or more relative to opposing part P. In case when less than 68% of opposing part P show that the closest distance X is 50 nm or more relative to opposing part P, there are many places where particles are as close as possible or contact. Therefore μ0 is heightened and magnetization is easily saturated, however, an improvement of the DC superimposing characteristic cannot be expected. Considering above, a good DC superimposing characteristic can be obtained by 68% or more of opposing part P, where the closest distance X is 50 nm or more relative to opposing part P.

From the observation of the smooth cross section of the soft magnetic metal dust core, an occupancy area ratio of the soft magnetic metal powder relative to the cross section is preferably 90% or more and 95% or less. A high filling rate of the soft magnetic metal powder increases the saturation of the magnetization. Consequently, the soft magnetic metal dust core is superior in the DC superimposing characteristic.

As a component of the nonmagnetic material, silicone resin is preferably used. The silicone resin has a moderate flow property. Thus, by coating the silicone resin on the particle surfaces of the soft magnetic metal powder having a high circularity, the uniformity of the nonmagnetic material improves. In addition, the silicone resin also shows the moderate flow property when pressure molding. Thus, the nonmagnetic material easily exists between particles of the soft magnetic metal powder and the distance between particles can be particularly controlled. Consequently, the DC superimposing characteristic of the soft magnetic metal dust core can be improved.

Boron nitride is preferably used as a component forming the nonmagnetic material. Boron nitride has a structure in which layers of hexagonal boron nitrides are linked and a binding strength between the layers is weak, therefore layers mutually slid easily. In case when boron nitride coats the soft magnetic metal powder, boron nitride is easily removed from the soft magnetic metal powder when a stress is applied while pressure molding. Namely, at an early stage of the molding, boron nitride is removed from the surface of the soft magnetic metal powder and can fill voids between a plurality of particles in priority. The voids are formed by a plurality of particles of the soft magnetic metal powder. Distance between the particles can be made as short as possible, due to the removal of boron nitride from the particle surfaces of the soft magnetic metal powder. Thus, a high relative permeability can be obtained. While, the filled boron nitride may serve like a wedge by filling the voids between a plurality of particles with boron nitride, and there is an effect to inhibit the contacts between particles of the soft magnetic metal powder even when densely molded. Namely, with a formation of a condensed structure of boron nitride in the voids between a plurality of particles, a structure holding an uniform and short distance between particles can be formed without a contact between the particles, and the flow of the magnetic flux becomes uniform. Thus, a good DC superimposing characteristic can be obtained.

Existence of boron nitride on the cross section of the soft magnetic metal dust core can be noticed from distribution states of “B” and “N” using EPMA. “B” content and “N” content in the soft magnetic metal dust core can be obtained by a quantitative analysis. “B” content can be measured by Inductively Coupled Plasma Atomic Emission Spectroscopy (ICP-AES). “N” content can be measured by using a nitrogen amount analyzer.

A particle size distribution of soft magnetic metal powder 11 is measured. In case when d50% is a particle diameter of a 50% particle, which is obtained by accumulating particle numbers from smaller size, d50% is preferably within 20 μm or more and 70 μm or less. By determining d50% to be within 20 μm or more and 70 μm or less, a loss by eddy current of the soft magnetic metal powder in a high frequency can be inhibited, and μ0 becomes easy to adjust within a desired range, and a superior DC superimposing characteristic can be obtained. Further, to inhibit an iron loss of the soft magnetic metal powder and to obtain a good DC superimposing characteristic, d50% is more preferable to be within 30 μm or more and 60 μm or less.

A raw material powder of the soft magnetic metal powder constituting the soft magnetic metal dust core is the soft magnetic metal powder mainly including iron, and more preferably including “B”. “B” content in the raw material powder is preferably 2.0 mass % or less. When “B” content exceeds 2.0 mass %, an amount of boron nitride, the nonmagnetic component, becomes excessive and the saturated magnetic flux density becomes too low.

A method of manufacturing the raw material powder of the soft magnetic metal powder can be a water atomizing method, a gas atomizing method, etc. Particles having a high circularity are obtainable by using the gas atomizing method.

Nitriding heat treatment is performed to the raw material powder including “B” in an unoxidizing atmosphere including nitride at a temperature rising rate of 5° C./min. or less, a temperature of 1,000 to 1,500° C., and a holding time of 30 to 600 min. By performing the nitriding heat treatment, “N” in the atmosphere and “B” in the raw material powder are reacted and uniformly form a boron nitride coating on the metal particle surfaces. In case when the heat treatment temperature is less than 1,000° C., the nitriding reaction of “B” in the raw material powder becomes insufficient, a ferromagnetic phase such as Fe₂B remains, a coercive force becomes high, and a loss increases. In case when the heat treatment temperature exceeds 1,500° C., nitriding rapidly advances and completes the reaction. Thus, there is no effect for rising the temperature after the completion of the reaction. Nitriding heat treatment is performed in an unoxidizing atmosphere including “N”. Heat treatment is performed in an unoxidizing atmosphere in order to prevent an oxidation of the soft magnetic metal powder. If the temperature rising rate is too high, the raw material powder particles reaches a sintering temperature and the raw material powder sinters before a sufficient amount of boron nitride is produced. Thus, the temperature rising rate is 5° C./min. or less.

The nonmagnetic material is coated on the raw material powder of the soft magnetic metal powder and a granulated substance is obtained. As the nonmagnetic material, epoxy resin including nanosilica, silicone resin, etc. is added to the soft magnetic metal powder, and kneaded by a kneader or so. The kneaded material is put into such as a stainless steel container and dried by rotating the container. The addition of the nonmagnetic material is performed by dividing a predetermined additional amount into a multiple amount and added thereof for a multiple times, and repeatedly performing kneading and drying processes for multiple times till the additional amount of the nonmagnetic material becomes the predetermined amount. Thus, granules can be obtained. The granules are the soft magnetic metal powder of a high circularity, thus, a uniform nonmagnetic material coat can be obtained.

The obtained granules are filled in a mold of a desired shape and pressure molded to obtain the molded body. The molding pressure can be suitably selected considering a composition of the soft magnetic metal powder or a desired molding density, however, it is around 1,200 to 2,000 MPa in general. In order to inhibit a generation of a distortion inside the soft magnetic metal dust core, it is preferably within 1,200 to 1,600 MPa. Lubricant can be used when necessary.

The granules, in which the nonmagnetic material not including boron nitride are coated on the soft magnetic metal powder having a high circularity, have an uniform coating. Thus, when pressure molded to make a highly-dense molded body, fragile parts by the pressure application is hardly caused and the nonmagnetic material is hardly removed. Thus, the nonmagnetic material can be thinly remained between the particles of the soft magnetic metal powder. The nonmagnetic material is effective for keeping the distance between particles of the soft magnetic metal powder, and that a generation of an area where particles of the soft magnetic metal powder contact can be inhibited. Therefore, an electrical insulation property of the particles can be added and an excessive promotion of the magnetization can be inhibited, and as a result, a good DC superimposing characteristic can be obtained. Distribution of nonmagnetic material of the soft magnetic metal dust core can be obtained by observing areas where particles fall off in the smooth cross section of the soft magnetic metal dust core using a scanning electron microscope, and measuring density distribution of Si, O and C using an energy dispersive X-ray spectrometry (EDS).

On the other hand, in case of the granules in which the nonmagnetic material includes boron nitride, when a local stress concentrates on a contact face of the soft magnetic metal powder at an early stage of the pressure molding, boron nitride is removed because the soft magnetic metal powder and boron nitride are weak in joining strength. The removed boron nitride flows to the voids according to a plastic deformation of the soft magnetic metal powder, the boron nitride fills the voids between a plurality of particles of the soft magnetic metal particles. Here, when the particles have a high circularity, the flow of boron nitride by pressure application is hardly inhibited and boron nitride fills voids between a plurality of particles in preference to the other nonmagnetic materials. Thus, boron nitride existing in a grain boundary becomes a trace amount, and that a relative permeability will not be lowered by an excessive large distance between particles. And, more of the other nonmagnetic materials can be remained in the grain boundary. In case of a highly-dense molded body, the other nonmagnetic materials have an effect to keep the distance between particles of the soft magnetic metal powder uniform, and that a good DC superimposing characteristic can be obtained.

The obtained molded body is thermally cured to be the soft magnetic metal dust core. Or, the obtained molded body is heat-treated to remove a distortion formed while molding to be the soft magnetic metal dust core. Temperature of the heat treatment is 500 to 800° C. and is preferably performed in an unoxidizing atmosphere such as nitrogen atmosphere or argon atmosphere.

Thereby, the soft magnetic metal dust core having a structure of the invention can be obtained.

Hereinbefore, preferable embodiments of the invention are described, but the invention is not limited thereto. The invention can be varied within a summary of the invention.

### Examples

As raw material powders, by a gas atomizing method, soft magnetic metal powders having a composition of Fe-3.0Si, Fe-4.5Si and Fe-6.5Si, and soft magnetic metal powders including “B” to coat a desired boron nitride on the surface of the soft magnetic metal powders were manufactured. The soft magnetic metal powders including “B” was put into a tubular furnace, and the nitriding heat treatment was performed at a heat treatment temperature of 1,300° C. and a holding time of 30 min. in a nitrogen atmosphere, then the soft magnetic metal powder was manufactured. To obtain a desired particle size of the obtained soft magnetic metal powder, a dry classification process was performed. The d50% of the soft magnetic metal powder was measured with a laser diffraction particle size distribution measuring apparatus (HELOS system, made by Sympatec Co.). Compositions, manufacturing methods, the presence or absence of boron content, and d50% are shown in Table 1.

TABLE 1

| | | | | | | | | Content |
|---|---|---|---|---|---|---|---|---|
| | | | | | | Additional | | ratio of |
| | | | | | | amount | | particles |
| | | | | | | of non- | | having |
| | | | | | Non- | magnetic | Molding | 0.75 or more |
| | Main | Manufactoring | B | d50% | magnetic | component | pressure | circularity |
| | component | method | content | [μm] | component | [mass %] | [MPa] | [%] |
| Ex. 1-1 | Fe-4.5Si | gas | absence | 25 | nanosilica | 0.75 | 1200 | 83 |
| Ex. 1-2 | Fe-3.0Si | gas | absence | 23 | nanosilica | 0.75 | 1200 | 81 |
| Ex. 1-3 | Fe-6.5Si | gas | absence | 24 | nanosilica | 0.75 | 1200 | 82 |
| Ex. 1-4 | Fe-4.5Si | gas | absence | 25 | nanosilica | 1.00 | 1400 | 82 |
| Ex. 1-5 | Fe-4.5Si | gas | absence | 26 | nanosilica | 1.15 | 1600 | 83 |
| Ex. 1-6 | Fe-4.5Si | gas | absence | 26 | nanosilica | 1.25 | 2000 | 82 |
| Ex. 1-7 | Fe-4.5Si | gas | absence | 24 | silicone | 0.75 | 1200 | 82 |
| | | | | | resin | | | |
| Ex. 1-8 | Fe-4.5Si | gas | absence | 35 | nanosilica | 0.75 | 1200 | 83 |
| Ex. 1-9 | Fe-4.5Si | gas | absence | 44 | nanosilica | 0.75 | 1200 | 83 |
| Ex. 1-10 | Fe-4.5Si | gas | absence | 55 | nanosilica | 0.75 | 1200 | 80 |
| Ex. 1-11 | Fe-4.5Si | gas | absence | 44 | silicone | 1.00 | 1200 | 82 |
| | | | | | resin | | | |
| Ex. 1-12 | Fe-4.5Si | gas | presence | 26 | nanosilica | 0.50 | 1200 | 84 |
| Ex. 1-13 | Fe-4.5Si | gas | presence | 23 | nanosilica | 0.50 | 1200 | 85 |
| Ex. 1-14 | Fe-4.5Si | gas | presence | 25 | silicone | 1.00 | 1200 | 88 |
| Ex. 1-15 | Fe-4.5Si | gas | presence | 23 | silicone | 1.00 | 1200 | 90 |
| Ex. 1-16 | Fe-4.5Si | gas | presence | 45 | silicone | 1.00 | 1200 | 90 |
| | | | | | resin | | | |
| Ex. 1-17 | Fe-4.5Si | gas | presence | 31 | silicone | 1.15 | 1600 | 88 |
| | | | | | resin | | | |
| Comp. | Fe-4.5Si | gas | absence | 24 | nanosilica | 0.75 | 800 | 85 |
| Ex. 1-1 | | | | | | | | |
| Comp. | Fe-4.5Si | gas | absence | 24 | nanosilica | 0.75 | 1200 | 80 |
| Ex. 1-2 | | | | | | | | |
| Comp. | Fe-4.5Si | gas | absence | 26 | nanosilica | 0.75 | 1200 | 73 |
| Ex. 1-3 | | | | | | | | |
| | Occupancy | | | | | | | |
| | ratio in | | | | | | | |
| | the cut | | | | | | | |
| | surface | | | | | | | |
| | of the soft | | | | | | | |
| | magnetic | | | | Number | Ratio where | | |
| | metal | | | | of | X ≧ 50 μm to | | |
| | powder | B content | N content | Particle | Opposing | opposing | | |
| | [%] | [mass %] | [mass %] | number | part P | part P [%] | μ0 | μ(8 kA/m) |
| Ex. 1-1 | 85 | — | — | 112 | 60 | 76 | 83 | 43 |
| Ex. 1-2 | 89 | — | — | 120 | 70 | 70 | 86 | 42 |
| Ex. 1-3 | 82 | — | — | 108 | 55 | 80 | 80 | 42 |
| Ex. 1-4 | 90 | — | — | 104 | 60 | 73 | 93 | 44 |
| Ex. 1-5 | 93 | — | — | 122 | 72 | 72 | 102 | 43 |
| Ex. 1-6 | 95 | — | — | 116 | 70 | 68 | 108 | 43 |
| Ex. 1-7 | 86 | — | — | 104 | 59 | 77 | 85 | 45 |
| Ex. 1-8 | 87 | — | — | 78 | 44 | 75 | 90 | 44 |
| Ex. 1-9 | 89 | — | — | 65 | 38 | 71 | 94 | 44 |
| Ex. 1-10 | 86 | — | — | 52 | 32 | 68 | 100 | 43 |
| Ex. 1-11 | 89 | — | — | 69 | 41 | 80 | 88 | 46 |
| Ex. 1-12 | 85 | 0.51 | 0.62 | 117 | 64 | 85 | 82 | 47 |
| Ex. 1-13 | 84 | 0.78 | 0.93 | 119 | 67 | 88 | 80 | 48 |
| Ex. 1-14 | 85 | 0.42 | 0.57 | 110 | 64 | 90 | 81 | 47 |
| Ex. 1-15 | 85 | 0.78 | 0.95 | 100 | 62 | 93 | 82 | 51 |
| Ex. 1-16 | 87 | 0.75 | 0.90 | 60 | 38 | 85 | 88 | 49 |
| Ex. 1-17 | 91 | 0.73 | 0.88 | 80 | 52 | 86 | 89 | 52 |
| Comp. | 78 | — | — | 92 | 6 | — | 52 | 37 |
| Ex. 1-1 | | | | | | | | |
| Comp. | 84 | — | — | 104 | 43 | 58 | 96 | 35 |
| Ex. 1-2 | | | | | | | | |
| Comp. | 82 | — | — | 103 | 25 | 68 | 92 | 31 |
| Ex. 1-3 | | | | | | | | |

To 100 mass % of the soft magnetic metal powder in Table 1, nonmagnetic material of 0.50, 0.75, 1.00, 1.15, 1.25 mass % of epoxy resin including nanosilica or silicone resin, diluted by xylene were divided and added in 5 times. Processes of kneading using a kneader and drying by rotating in the stainless steel container were repeated. The obtained aggregates were graded to be 355 μm or less and the granules were obtained. The granules were filled in a mold of a toroidal shape having an outer diameter of 17.5 mm and an inner diameter of 11.0 mm and pressured with molding pressures of 1,200 MPa, 1,400 MPa, 1,600 MPa or 2,000 MPa to obtain the molded body. The core weight was 5 g. The obtained molded body was heat treated by a belt furnace at 750° C. for 30 min. in nitrogen atmosphere, and obtained the soft magnetic metal dust core. Table 1 shows the nonmagnetic materials added to the raw material powder, the additional amounts of the nonmagnetic materials and the molding pressures (Ex. 1-1 to 1-17).

The same was prepared in the same manner as Ex. 1-1, except the molding pressure was changed to 800 MPa (Comp. Ex. 1-1). The same was prepared in the same manner as Ex. 1-1, except the coat of the nonmagnetic material was prepared by adding the nonmagnetic material in one time, kneaded using the kneader, dried in a tray to prepare the granules (Comp. Ex. 1-2). The same was prepared in the same manner as Ex. 1-1, except manufacturing method of the raw material powder was changed to a water atomizing method (Comp. Ex. 1-3).

Inductance of the soft magnetic metal dust core at a frequency of 100 kHz was measured using LCR meter (4284A made by Agilent Technologies, Ltd.) and DC bias power source (42841A made by Agilent Technologies, Ltd.). And a relative permeability of the soft magnetic metal dust core was calculated from the inductance. In both cases when DC superimposed magnetic fields are 0 A/m and 8,000 A/m were measured, and relative permeability of each case is shown in Table 1 as μ0 and μ (8 kA/m).

The soft magnetic metal dust core was fixed with a cold embedding resin, a cross section was cut out at a plane passing through the points existing 3 mm inside the soft magnetic metal dust core surface, and the cross section was polished to a mirror surface. The cross section was observed by SEM, and the cross section image was obtained. In the cross section image, a plural number of circles were drawn to calculate the distance between adjacent particles of the soft magnetic metal powder. Then, length L where the distance between particles is continuously 400 nm or less was calculated. And opposing part P where length L is continuous for 10 μm or more was taken out, and the closest distance X among the distances between particles at each opposing part P was calculated. Particle number “n” of the soft magnetic metal powder included in the observed cross section was evaluated. Particle numbers “n”, numbers of opposing part P, ratios of opposing part P, where the closest distance X is 50 nm or more relative to said opposing part P, are shown in Table 1.

100 particles included in the cross section of the soft magnetic metal dust core were randomly observed. And Wadell's circularity of each particle was measured, and a ratio of particles having the circularity of 0.75 or more was calculated. In addition, a compositional image of the cross section was photographed. From the contrast of the display, an area ratio of a metal phase to a viewing area was calculated. Results are shown in Table 1.

The soft magnetic metal dust core including “B” was crushed, and a powder of 250 μm or less was manufactured. The content of “B” in the powder was measured by ICP-AES (ICPS-8100CL made by Shimadzu Corp.), and the result was determined as “B” content in the soft magnetic metal dust core. Further, a nitrogen content in the powder was measured with a nitrogen amount analyzer (TC600 made by LECO Corp.), and the result was determined as “N” content in the soft magnetic metal dust core. Results of the “B” and “N” contents are shown in Table 1.

From Table 1, it can be noticed that Ex. 1-1 to 1-17 each show 40 or more μ (8 kA/m), which is a good DC superimposing characteristic. Thus, when observing the field of view including “n” or more particles of the soft magnetic metal powder on the grinded smooth cross section of the dust core including the soft magnetic metal powder and the nonmagnetic material, it was confirmed that a good DC superimposing characteristic can be obtained and a superior soft magnetic metal dust core can be provided when the soft magnetic metal powder is coated with the nonmagnetic material, the circularity of 80% or more particle cross section of the soft magnetic metal powder is 0.75 or more and 1.00 or less, a number of opposing part P is n/2 or more, in which opposing part P is 10 μm or more and the length L is continuous length where the distances between particles of the soft magnetic metal powder are 400 nm or less, and when the closest distance X is the shortest distance among the distances between particles of each “P”, 68% or more of opposing part P show that the closest distance X is 50 nm or more relative to opposing part P.

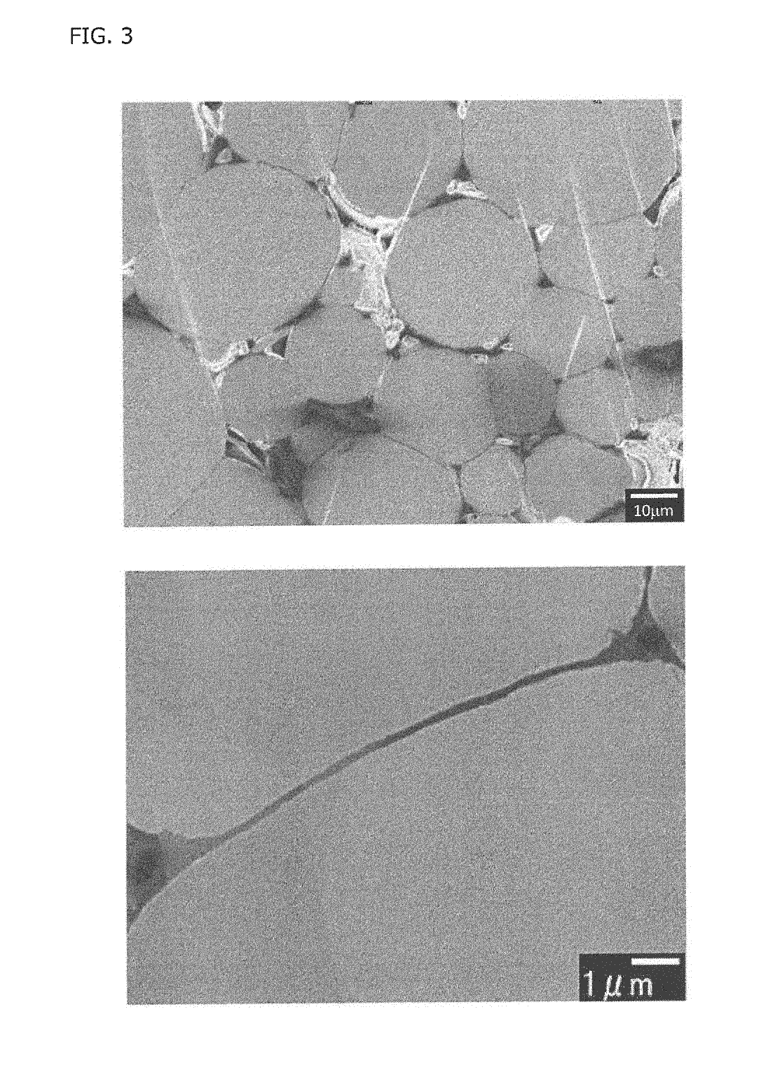

The observation results of the grinded cross section of the soft magnetic metal dust core of Ex. 1-1 are shown in FIG. 3. Looking at FIG. 3, it can be notified that the particles of the soft magnetic metal power do not contact and particle surfaces mutually keep distances between the particles, and further, most of the particles are proximate showing distances between the particles 400 nm or less. Namely, transmit of the magnetization between particles are uniformly progressed on a plane which improves the uniformity inside the soft magnetic metal dust core. This is effective for DC superimposing characteristic improvement.

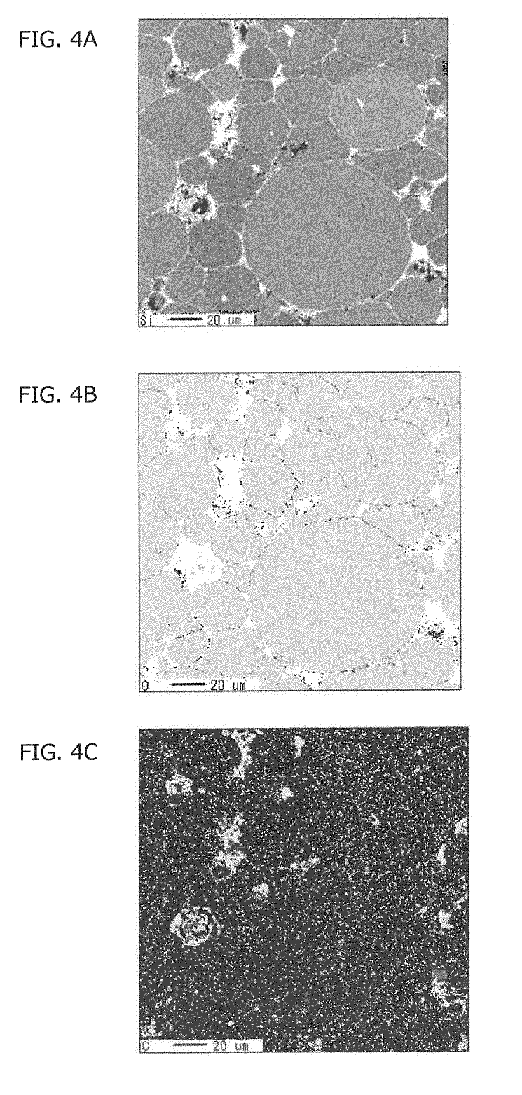

On the grinded cross section of the soft magnetic metal dust core of Ex. 1-1, an area where particles fell off was observed by a scanning electron microscope. Si, O and C density distributions were measured by an energy dispersive X-ray spectrometry (EDS), and the results are shown in FIG. 4A, FIG. 4B and FIG. 4C respectively. In Figs, densities of each element becomes higher as it becomes close to white. When distributions of “Si”, “O” and “C” are compared in FIG. 4A, FIG. 4B and FIG. 4C, it can be noticed that “O” and “C” are distributed in high concentration at the same place where “Si” is highly concentrated. The nonmagnetic material including “Si”, “O” and “C” is distributed in an area where Fe does not exist, and it can be confirmed that the nonmagnetic material exists between particles of the soft magnetic metal powder.

Examples 1-1, 1-2 and 1-3 show μ0 of 86 or less. While, Examples 1-4, 1-5, 1-6 and 1-17 show μ (8 kA/m) of 43 or more and in addition, μ0 of 89 or more, providing particularly good DC superimposing characteristic. When cross section of such soft magnetic metal dust core is observed, an occupancy ratio of the soft magnetic metal powder in the cross section is 90% or more and 95% or less, which is the soft magnetic metal dust core having a high soft magnetic metal powder content. High soft magnetic metal powder content increases the saturation of magnetization. In case when the saturation magnetization is increased, even when μ0 has a large value and a high DC magnetic field is applied, the saturation of the magnetization will be hardly reached, thus, DC superimposing characteristic will be improved. While, the soft magnetic metal dust core of the invention is required to include a predetermined amount of the nonmagnetic material, thus, the dust core, in which the occupancy ratio of the soft magnetic metal powder on the cross section of the soft magnetic metal dust core is more than 95%, was difficult to manufacture. Considering above, it can be said that the soft magnetic metal dust core, in which an occupancy ratio of the soft magnetic metal powder on the cross section is 90% or more and 95% or less when observing the cross section of said soft magnetic metal dust core, is more preferable.

Examples 1-1, 1-2 and 1-3 show μ (8 kA/m) of 43 or less. While, Examples 1-7, 1-11, 1-14, 1-15, 1-16 and 1-17 show μ (8 kA/m) of 46 or more providing particularly good DC superimposing characteristic. These are the soft magnetic metal dust cores in which silicone resin was included as the nonmagnetic material. By including silicone resin as the nonmagnetic material, the rate, in which the closest distance X among the distances between particles of the soft magnetic metal powder is 50 nm or more, increased. Namely, a generation of places where particles contact or become extremely adjacent is suppressed and the saturation of magnetization is hardly reached if a high DC magnetic field is not applied, thus, DC superimposing characteristic is improved. Considering above, it is more preferable that the nonmagnetic material included in the soft magnetic metal dust core is silicone resin.

Examples 1-1, 1-2 and 1-3 show μ (8 kA/m) of 43 or less. While, Examples 1-12, 1-13, 1-14, 1-15, 1-16 and 1-17 show μ (8 kA/m) of 47 or more, providing particularly good DC superimposing characteristic. These are the soft magnetic metal dust cores in which boron nitride was included as the nonmagnetic material. By including boron nitride as the nonmagnetic material, the rate, in which the closest distance X among the distances between particles of the soft magnetic metal powder is 50 nm or more, increased. Namely, a generation of places where particles contact or become extremely close is suppressed and the saturation of magnetization is hardly reached if a high DC magnetic field is not applied, thus, DC superimposing characteristic is improved. While, an excessive boron nitride content reduces a content ratio of the soft magnetic metal powder or generates an increase in the distance between particles. Thus, relative permeability is lowered and a good DC superimposing characteristic cannot be obtained. Considering above, it is more preferable that “B” content is 0.80 mass % or less and “N” content is 1.00 mass % or less, with respect to the soft magnetic metal dust core.

Example 1-1 shows the initial permeability μ0 of 83. While, Examples 1-8, 1-9, 1-10, 1-11, 1-16 and 1-17 show μ (8 kA/m) of 43 or more and in addition, μ0 of 88 or more, providing DC superimposing characteristic of a particularly good relative permeability. These are the soft magnetic metal dust cores including the soft magnetic metal powder in which d50% is 30 μm or more and 60 μm or less. In case when the particle diameter of the soft magnetic metal powder is increased, a number of particles contained in a unit length decreases and an effect of lowering μ0 by grain boundaries is reduced, thus, improves μ0. Considering above, by adjusting the particle diameter of the soft magnetic metal powder, the soft magnetic metal dust core showing a predetermined initial permeability can be obtained. Therefore, it is more preferable to set d50% of the soft magnetic metal powder to 30 μm or more and 60 μm or less.

In Comp. Ex. 1-1, a measurement number of opposing part P of the particles of the soft magnetic metal powder on cross section of the soft magnetic metal dust core cannot be sufficiently observed, considering the particle numbers of the soft magnetic metal powder. In this case, it has a structure in which an area, where the particles of the soft magnetic metal powder are proximate and the distances between particles are 400 nm or less, is small, or particles of the soft magnetic metal powder are mutually separated. Thus, the relative permeability is lowered and a good DC superimposing characteristic cannot be obtained. Consequently, the soft magnetic metal dust core showing μ (8 kA/m) of less than 40 can only be obtained. In Examples 1-1 to 1-17, n/2 or more of opposing part P of the soft magnetic metal powder on cross section of the soft magnetic metal dust core can be observed, relative to the particle number “n” of the soft magnetic metal power. Thus, μ (8 kA/m) exceeds 40. Considering above, the measurement number of opposing part P of the soft magnetic metal powder is required to be n/2 or more, with respect to the particle number “n” of the soft magnetic metal powder.

In Comp. Ex. 1-2, the rate, in which the closest distance X among the distances between particles of the soft magnetic metal powder is 50 nm or more, is 58%, and there are many areas where many particles of the soft magnetic metal powder contact or being close by an extremely short distance. Thus, magnetization is progressed when DC magnetic field is applied, and that μ0 becomes high while μ (8 kA/m) becomes less than 40. Therefore, a good DC superimposing characteristic cannot be obtained. In Examples 1-1 to 1-17, 68% or more of opposing part P show that the closest distance X among the distances between particles of the soft magnetic metal powder is 50 nm or more relative to the opposing part P, particles of the soft magnetic metal powder are prevented to be mutually approximate, and μ (8 kA/m) is 40 or more. Considering above, it is preferable that 68% or more of opposing part P show that the closest distance X among the distances between particles of the soft magnetic metal powder is 50 nm or more relative to the opposing part P.

In Comp. Ex. 1-3, a rate, in which the circularity of the soft magnetic metal powder on the cross section of the soft magnetic metal dust core is 0.75 or more, was 73%, and the silicon compound coated on the soft magnetic metal powder was unevenly formed. Thus, the silicon compound easily removed when molding, many places where particles are mutually approximate generated, and a good DC superimposing characteristic was not obtained. As a result, since there are many places where particles are mutually approximate, μ0 became high while μ (8 kA/m) became as small as less than 40. In Examples 1-1 to 1-17, a rate, in which the circularity of the soft magnetic metal powder on the cross section of the soft magnetic metal dust core is 0.75 or more, was 80% or more, and that the silicon compound coated on the soft magnetic metal powder was evenly formed, and particles were prevented to be mutually approximate when molding. Considering above, it is preferable that μ (8 kA/m) is 40 or more and a rate, in which the circularity of the soft magnetic metal powder is 0.75 or more, is 80% or more.

As mentioned, the soft magnetic metal dust core of the invention can provide a high inductance even under a DC superposed condition, and that it is capable to enhance the efficiency and realize downsizing. Thus, the dust core of the invention can be widely and efficiently used as inductors such as a power circuit or electric and magnetic devices such as a reactor.

### NUMERICAL REFERENCES

10 . . . Soft magnetic metal dust core
11 . . . Soft magnetic metal powder
12 . . . Nonmagnetic material
13 . . . Distance between particles
14 . . . Length L, where the distance between particles is 400 nm or less
15 . . . Opposing part P, where length L is 10 μm or more
16 . . . Coil
17 . . . Reactor

1. A soft magnetic metal dust core comprising a soft magnetic metal powder and a nonmagnetic material, wherein
when observing a field of view including “n”, a natural number of 50 or more, particles of the soft magnetic metal powder on a grinded smooth cross section of the dust core,
the soft magnetic metal powder is coated by the nonmagnetic material, and
a number of an opposing part P is n/2 or more, wherein
the opposing part P is a part where a length L is 10 μm or more, and
the length L is a continuous length where a distance between particles of the soft magnetic metal powder is 400 nm or less.

2. The soft magnetic metal dust core according to claim 1, wherein
when observing the field of view on the smooth cross section,
a circularity of a cross section of 80% or more particles of the soft magnetic metal powder is 0.75 or more and 1.00 or less.

3. The soft magnetic metal dust core according to claim 1, wherein
when observing the field of view on the smooth cross section,
68% or more of the opposing part P show that a closest distance X is 50 nm or more, wherein
the closest distance X is the shortest distance among the distances between particles at the opposing part P.

4. The soft magnetic metal dust core according to claim 1, wherein
when observing the field of view on the smooth cross section,
an occupancy area ratio of the soft magnetic metal powder to the field of view is 90% or more and 95% or less.

5. The soft magnetic metal dust core according to claim 1, wherein
the nonmagnetic material includes Silicon (Si) and Oxygen (O).

6. The soft magnetic metal dust core according to claim 1, wherein
the nonmagnetic material includes boron nitride, and includes 0.80 mass % or less of Boron (B) and 1.00 mass % or less of Nitrogen (N), with respect to the soft magnetic metal dust core.

7. The soft magnetic metal dust core according to claim 1, wherein, according to a particle size distribution of the soft magnetic metal powder,
d50% is 20 μm or more and 70 μm or less,
when d50% is a particle diameter of a 50% particle, obtained by accumulating particle numbers from smaller size.

8. A reactor having the soft magnetic metal dust core according to claim 1.
